(19) United States
(12) Patent Application Publication
(10) Pub. No.: US 2011/0180300 A1
(43) Pub. Date: Jul. 28, 2011

(54) FLAME RETARDANT THERMOPLASTIC ELASTOMERS

(75) Inventors: Jiren Gu, Naperville, IL (US); Krishna Venikataswany, Crystal Lake, IL (US)

(73) Assignee: POLYONE CORPORATION, Avon Lake, OH (US)

(21) Appl. No.: 13/121,242

(22) PCT Filed: Sep. 25, 2009
(86) PCT No.: PCT/US09/58440

§ 371 Date: Mar. 28, 2011

Related U.S. Application Data
(60) Provisional application No. 61/101,512, filed on Sep. 30, 2008.

(51) Int. Cl. H01B 3/44; C08K 5/51

(52) U.S. Cl. 174/110 PM; 524/127

(57) ABSTRACT

A thermoplastic elastomer (TPE) is disclosed which is flame retardant and essentially halogen-free. The TPE is a copolyester (COPE). Two essentially halogen-free flame retardants (HFFRs) are used: organo-phosphinates and melamine polyphosphate. The compound is useful for wire and cable insulation.

### CLAIM OF PRIORITY

This application claims priority from U.S. Provisional Patent Application Ser. No. 61/101,512 bearing Attorney Docket Number 12008021 and filed on Sep. 30, 2008, which is incorporated by reference.

### FIELD OF THE INVENTION

This invention relates to thermoplastic elastomers, polymer compounds which exhibit elasticity while remaining thermoplastic, which are also flame retardant.

### BACKGROUND OF THE INVENTION

The world of polymers has progressed rapidly to transform material science from wood and metals of the 19^{th} Century to the use of thermoset polymers of the mid-20^{th} Century to the use of thermoplastic polymers of later 20^{th} Century.

Thermoplastic elastomers combine the benefits of elastomeric properties of thermoset polymers, such as vulcanized rubber, with the processing properties of thermoplastic polymers.

For safety reasons in some uses, thermoplastic elastomers should be flame retardant. There is customer demand for essentially non-halogen flame retardant (HFFR) thermoplastic elastomers (TPE).

Today no HFFR technology is reported to have an alternating current (AC) cable meeting both (a) flexibility close to polyvinyl chloride (PVC) and (b) comply Underwriter's Laboratory (UL) 62 critical requirements such as VW-1 for both insulation and jacket, 150° C. deformation, and heat shock test, tensile/elongation and 7 day heat aging at 100° C. and 121° C.

Copolyester (COPE) thermoplastic elastomer compounds using halogen-based flame retardants have been commercially available for years. But the art seeks to avoid the use of halogenated flame retardants.

Patent publication WO/2006/121549 reports the use of HFFR organo-phosphinates, organic phosphates, and inorganic phosphates with thermoplastic polyurethane (TPU).

### SUMMARY OF THE INVENTION

The advantage of using COPE over TPU as a base material or for wire and cable insulation is that, at same hardness/flexibility COPE based cable has better temperature resistance TPU based cable at same hardness. In other words, to meet the UL 62150° C. heat requirement, COPE cable is significantly more flexible than TPU cable. To have a flexibility comparable to PVC, a halogenated compound, it is important to use COPE at a hardness no higher than Shore Hardness 33D, preferable no higher than Shore Hardness 30D. Soft COPE has lower tensile and therefore is more difficult to formulate soft COPE to meet cable tensile/VW-1 requirements.

What the art needs is a HFFR COPE TPE compound which passes UL 62 VW-1 flame tests for use in wire and cable insulation applications.

In this invention, a combination of organo-phosphinates and melamine-polyphosphate as flame retardants has been found very effective HFFR for COPE to achieve UL 62 VW-1 flame test in this invention. Organic phosphates can optionally be added to modify the hardness and viscosity.

In this invention, “HFFR” means that there is no intention to include any halogen moieties in any of the ingredients of the compound of the present invention, but that one can cannot control trace amounts of impurities that may exist in such ingredients. In other words, HFFR means the flame retardants are essentially halogen-free.

Unfortunately, HFFRs are very sensitive to processing conditions typically experienced by TPEs. Therefore, there is little predictable to one of ordinary skill in the art in the creation of a HFFR TPE, whether the TPE is a TPU, a COPE, or a styrenic block copolymer (SBC).

The present invention solves the problem by formulating a HFFR COPE TPE that utilizes a combination of organo-phosphinates and melamine-polyphosphate as flame retardants, and optionally also organic phosphates, in order to achieve UL 62 VW-1 flame test for compounds of this invention.

One aspect of the invention is an essentially halogen-free thermoplastic elastomer compound, comprising (a) copolyester-containing thermoplastic elastomer; (b) an organo-phosphinate-containing flame retardant; and (c) a melamine-polyphosphate-containing flame retardant. Optionally, an organic phosphate-containing flame retardant can also be used.

Another aspect of the invention is a plastic article made from the compound, particularly insulation layers for wire and cable products.

Features of the invention will become apparent with reference to the following embodiments.

### EMBODIMENTS OF THE INVENTION

### Copolyester-Containing TPE

TPEs of the present invention are based on copolyesters and are often compounded with plasticizer, antioxidant, thermal stabilizer, and one or more secondary polymers.

Any copolyester TPE is a candidate for use in the present invention. The copolyester TPE is selected for its physical properties suitable for use as an insulation layer for wire and cable products.

Non-limiting examples of copolyester TPE include Hytrel brand TPEs from DuPont; Amite brand TPEs from DSM; Keyflex brand TPEs from LG Chemicals; and Skypel brand TPEs from SK Chemicals. Distributors of these products include the manufacturers who maintain websites for further information.

Essentially Halogen-Free Flame Retardant

It has been found that two different types of HFFR flame retardants are particularly suited to endure the processing conditions employed in compounding COPE TPEs and also achieve the UL 62 VW-1 flame test.

Organo-Phosphinate Flame Retardants

The first type of flame retardant is an organo-phosphinate. It has been found, particularly, that Exolit OP brand flame retardants from Clariant GmbH of Germany work well in compounds of the present invention. Presently preferred are Exolit OP 1230 and 1311 brand flame retardants.

Melamine Polyphosphate Flame Retardant

The second type of flame retardant is melamine polyphosphate. It is commercially available from Ciba under the Melapur 200 brand.

Optional Organo-Phosphate Flame Retardant

An optional third type of HFFR which can be used in TPEs of the present invention is an organo-phosphate, such as Phosflex 390 isodecyl diphenyl phosphate from Supresta of Ardsley, N.Y., USA. This isodecyl diphenyl phosphate is taught for use as a flame retardant plasticizer for poly(vinyl chloride) but has been found unexpectedly useful in COPE TPEs of the present invention.

Optional Additives

The TPE compounds of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppresants; expandable char formers; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

Table 1 shows the acceptable, desirable, and preferable ranges of ingredients for the HFFR-TPE of the present invention.

TABLE 1
Ranges of Ingredients

| Ingredient | | | |
|---|---|---|---|
| (Wt. Percent) | Acceptable | Desirable | Preferable |
| COPE TPE | 40-80% | 50-70% | 60-65% |
| Flame retardant | 10-40% | 15-35% | 20-30% |
| containing | | | |
| organo- | | | |
| phosphinate | | | |
| Flame retardant | 2-20% | 5-15% | 7-12% |
| containing | | | |
| melamine | | | |
| polyphosphate | | | |
| Flame retardant | 0-20% | 0-15% | 0-10% |
| containing | | | |
| organo-phosphate | | | |
| Secondary | 0-10% | 0-5% | 0-2% |
| Polymer(s) | | | |
| Anti-oxidant | 0-3% | 0-2% | 0-1% |
| Thermal | 0-3% | 0-2% | 0-1% |
| Stabilizer | | | |
| Other Optional | 0-15% | 0-10% | 0-5% |
| Additives | | | |

Processing

The preparation of compounds of the present invention is uncomplicated once the proper ingredients have been selected. The compound of the present can be made in batch or continuous operations.

Mixing in a continuous process typically occurs in an extruder that is elevated to a temperature that is sufficient to melt the polymer matrix with addition of all additives at the feed-throat, or by injection or side-feeders downstream. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is also elevated to a temperature that is sufficient to melt the polymer matrix to permit homogenization of the compound components. The mixing speeds range from 60 to 1000 rpm and temperature of mixing can be ambient to elevated. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### USEFULNESS OF THE INVENTION

COPE TPEs containing the particular combination of HFFRs, according to the present invention, has unexpected usefulness in wire and cable insulation and outer layers because such compounds are capable of passing the stringent Underwriter's Laboratory (UL) 62 critical requirements such as VW-1 for both insulation and jacket, 150° C. deformation, and heat shock test, tensile/elongation and 7 day heat aging at 100° C. and 121° C. The addition of anti-oxidant properties, thermal stabilization, and essentially halogen-free flame retardancy by those respective functional additives makes the HFFR COPE TPE of the present invention an excellent compound for molding into plastic articles which need flame retardancy when in use in enclosed spaces, including wire and cable which are almost always concealed from view. Use in motor vehicle passenger compartments and aircraft passenger compartments are two of many ways the compounds of the present invention used as wire and cable insulation layers can benefit people around the world.

### EXAMPLES

Table 2 shows two examples of the present invention, their formulations and sources of ingredients. Both examples were prepared in a twin screw extruder operating at about 193° C. in all zones and rotating at 300 rpm. The flame retardant ingredients were added through a side feeder downstream of the throat. Both examples resulted in pellets having a Shore A hardness of 86 (ASTM D2240, 10 s delay).

TABLE 2

| | Wt. % |
|---|---|
| Example 1 -- Insulation Layer | |
| Hytrel 3078 COPE TPE from DuPont (Shore Hardness | 60.7 |
| 30D) | |
| EXOLIT OP 1230 Organo-phosphinate flame | 27.96 |
| Retardant from Clariant | |
| MELAPUR 200 Melamine polyphosphate flame | 10.85 |
| retardant from Ciba Specialty Chemicals | |
| Irgafos 168 (CAS No. 31570-04-4) anti-oxidant from | 0.2 |
| Ciba Specialty Chemicals | |
| Irganox 1010 phenolic-based anti-oxidant from Ciba | 0.2 |
| Specialty Chemicals | |
| DYNAMAR FX 5911 fluoropolymer processing aid | 0.1 |
| from 3M/Dyneon | |
| Example 2 -- Jacket Layer | |
| Hytrel 3078 | 63.95 |
| EXOLIT OP 1230 | 20.67 |
| MELAPUR 200 | 8.01 |
| R104 Titanium Dioxide whitener | 3.46 |
| Kraton FG1901X-1000-05 functionalized styrene block | 1.98 |
| copolymer from Kraton LLC | |
| GE73709735 GREY colorant | 0.84 |
| Tinuvin 328 ultra-violet absorber from Ciba Specialty | 0.3 |
| Chemicals | |
| Tinuvin 622 LD light stabilizer from Ciba Specialty | 0.3 |
| Chemicals | |
| Irgafos 168 | 0.2 |
| Irganox 1010 | 0.2 |
| DYNAMAR FX 5911 | 0.1 |

TABLE 3
UL 62 and UL 1581

| | | | | | | Type and | | | | | |
|---|---|---|---|---|---|---|---|---|---|---|---|
| | Volex SP0712600 | | | | | Gauge | | SVE 90° C. 18AWG3C | | | |
| | | | Layer | | 1 | 2 | 3 | 4 | 5 | Values | Result |
| Unaged | 24 | Elongation | Jacket | ≧200% | 740% | 760% | 800% | 790% | 780% | 774% | Pass |
| | hour | | Insulating | | 700% | 676% | 684% | 692% | 672% | 685% | Pass |
| | | Tensile | Jacket | ≧8.3 | 8.84 | 8.76 | 8.56 | 8.3 | 9.11 | 8.71 | Pass |
| | | Strength | | MPA | | | | | | | |
| | | | Insulating | ≧5.5 | 8.86 | 8.59 | 8.21 | 8.03 | 8.14 | 8.37 | Pass |
| | | | | MPA | | | | | | | |
| Aged | | Elongation | Jacket | 75% of | 716% | 700% | 704% | 708% | 668% | 699% | Pass |
| for 168 | | | | Unaged | | | | | | (90%) | |
| hours | | | Insulating | 75% of | 440% | 424% | 424% | 444% | 440% | 440% | Fail |
| at | | | | Unaged | | | | | | (63.4%) | |
| 121° C. | | Tensile | Jacket | 75% of | 7.16 | 7.16 | 7.2 | 7.4 | 6.99 | 7.18 | Pass |
| | | Strength | | Unaged | | | | | | (82.4%) | |
| | | | Insulating | 75% of | 5.87 | 5.81 | 6.04 | 5.95 | 5.8 | 5.90 | Fail |
| | | | | Unaged | | | | | | (70.4%) | |

| Di-Electric Strength @ 1.5 kV * 1 min. | | In Air | OK | | | | | Pass |
|---|---|---|---|---|---|---|---|---|
| Insulation Resistance (0.76 GΩm) | | In Air | 21.64 | | | | | Pass |
| Heat Shock using 12.7 mm | Jacket | 24 hr. | No Crack | | | | | Pass |
| mandrel @ 150° C. for 1 hr. | Insulating | | No Crack | | | | | Pass |
| Deformation Test 150° C. * 1H | Jacket | 24 hr. | 26% 26% 29% | | | | | Pass |
| | Insulating | | 36.7% 36% 44% | | | | | Pass |
| 24 hour VW-1 Flame Test | Jacket | 1 | 0S | 13S | 7S | 6S | 7S | Pass |
| | | 2 | 0S | 3S | 11S | 12S | 6S | Pass |
| | | 3 | 0S | 1S | 15S | 10S | 3S | Pass |
| | | 4 | 0S | 1S | 28S | 7S | 6S | Pass |
| | | 5 | 0S | 13S | 10S | 13S | 0S | Pass |
| 24 hour VW-1 Flame Test | Insulating | 1 | 4S | 0S | 0S | 0S | 0S | Pass |
| | | 2 | 4S | 0S | 0S | 0S | 0S | Pass |
| | | 3 | 5S | 0S | 0S | 0S | 0S | Pass |
| | | 4 | 3S | 0S | 0S | 0S | 0S | Pass |
| | | 5 | 2S | 0S | 0S | 0S | 0S | Pass |

The above test shows that the jacket layer formulation of Example 2 passed even though the insulating layer formulation of Example 1 failed aged tensile strength and elongation. One skilled in the art can employ these data to reformulate in a manner that the insulating layer will also pass the UL 62 test.

It is very important to note that both the insulating layer of Example 1 and the jacket layer of Example 2 passed the VW-1 flame test in all respects.

The invention is not limited to the above embodiments. The claims follow.

What is claimed is:

1. An essentially halogen-free thermoplastic elastomer compound, comprising:
(a) copolyester-containing thermoplastic elastomer;
(b) an organo-phosphinate-containing flame retardant; and
(c) a melamine-polyphosphate-containing flame retardant.

2. The compound of claim 1, further comprising organic phosphate-containing flame retardant.

3. The compound of claim 1, further comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; or combinations of them.

4. The compound of claim 1, wherein the weight percents of the ingredients comprise:

| | |
|---|---|
| copolyester-containing thermoplastic | 40-80% |
| elastomer | |
| organo-phosphinate-containing flame | 10-40% |
| retardant | |
| melamine-polyphosphate-containing | 2-20% |
| flame retardant | |
| organic phosphate-containing flame | 0-20% |
| retardant | |
| secondary polymer(s) | 0-10% |
| anti-oxidant | 0-3% |
| thermal stabilizer | 0-3% |
| other optional additives | 0-15% |

5. The compound of claim 4, wherein the weight percents of the ingredients comprise:

| | |
|---|---|
| copolyester-containing thermoplastic | 60-65% |
| elastomer | |
| organo-phosphinate-containing flame | 20-30% |
| retardant | |
| melamine-polyphosphate-containing | 7-12% |
| flame retardant | |
| organic phosphate-containing flame | 0-10% |
| retardant | |
| secondary polymer(s) | 0-2% |
| anti-oxidant | 0-1% |
| thermal stabilizer | 0-1% |
| other optional additives | 0-5% |

6. A thermoplastic article, comprising the compound of claim 1.

7. The article of claim 6 in the form of wire and cable insulation.

8. The article of claim 7, wherein the insulation is a jacket layer, an insulating layer, or both.

9. A wire insulated by the compound of claim 1.

10. A cable insulated by the compound of claim 1.

11. The compound of claim 2, further comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; or combinations of them.

12. The compound of claim 11, wherein the weight percents of the ingredients comprise:

| | |
|---|---|
| copolyester-containing thermoplastic | 40-80% |
| elastomer | |
| organo-phosphinate-containing flame | 10-40% |
| retardant | |
| melamine-polyphosphate-containing | 2-20% |
| flame retardant | |
| organic phosphate-containing flame | 0-20% |
| retardant | |
| secondary polymer(s) | 0-10% |
| anti-oxidant | 0-3% |
| thermal stabilizer | 0-3% |
| other optional additives | 0-15% |

13. The thermoplastic article of claim 6, wherein the compound further comprises organic phosphate-containing flame retardant.

14. The article of claim 13, wherein the compound further comprises adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; or combinations of them.

15. The article of claim 13, wherein the compound has weight percents of ingredients comprising:

| | |
|---|---|
| copolyester-containing thermoplastic | 40-80% |
| elastomer | |
| organo-phosphinate-containing flame | 10-40% |
| retardant | |
| melamine-polyphosphate-containing | 2-20% |
| flame retardant | |
| organic phosphate-containing flame | 0-20% |
| retardant | |
| secondary polymer(s) | 0-10% |
| anti-oxidant | 0-3% |
| thermal stabilizer | 0-3% |
| other optional additives | 0-15% |

16. The article of claim 13 in the form of wire and cable insulation.

17. The article of claim 16, wherein the insulation is a jacket layer, an insulating layer, or both.

18. The wire of claim 9, wherein the compound further comprises organic phosphate-containing flame retardant.

19. The wire of claim 18, wherein the compound further comprises adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; additional processing aids; release agents; silanes, titanates and zirconates; slip and anti-blocking agents; stabilizers; stearates; ultraviolet light absorbers; viscosity regulators; waxes; or combinations of them.

20. The wire of claim 18, wherein the compound has weight percents of ingredients comprising:

| | |
|---|---|
| copolyester-containing thermoplastic | 40-80% |
| elastomer | |
| organo-phosphinate-containing flame | 10-40% |
| retardant | |
| melamine-polyphosphate-containing | 2-20% |
| flame retardant | |
| organic phosphate-containing flame | 0-20% |
| retardant | |
| secondary polymer(s) | 0-10% |
| anti-oxidant | 0-3% |
| thermal stabilizer | 0-3% |
| other optional additives | 0-15% |
